(19) United States
(12) Patent Application Publication
(10) Pub. No.: US 2002/0096455 A1
(43) Pub. Date: Jul. 25, 2002

(54) Tableware sorting apparatus and method

(76) Inventor: Cordell Francis, Moore, OK (US)

Correspondence Address: Edward L. White, P.C., 4th Floor, 50 Penn Place, Oklahoma City, OK, 73118-1803, US

(21) Appl. No.: 09/765,887

(22) Filed: Jan. 22, 2001

(51) Int. Cl. B07C 7/04

(52) U.S. Cl. 209/702

(57) ABSTRACT

The tableware chute for use with a tableware sorting station, the chute comprising: an attachment means for attaching the chute to an upper surface of the sorting station; a hollow body defining an upper entrance and a lower exit, the entrance disposed adjacent to an edge of the upper surface, and the exit disposed adjacent to the edge of the lower surface of the station, whereby soiled tableware placed in the entrance is conveyed downwardly through the hollow body and out of the exit into a receptacle disposed on a lower surface. Several different configurations for attaching the chute to the station are disclosed. Internal dividers placed into the chute for providing more than one conveyance therein are disclosed. A tableware sorting station using the chute is disclosed to facilitate processing soiled tableware.

### BACKGROUND OF THE INVENTION

a. Field of the Invention

This invention relates to apparatus and methods for sorting and washing tableware, such as flatware, plates, ramekins, and the like. In particular, the invention relates to apparatus and methods for sorting soiled tableware in restaurants or other establishments producing and serving large quantities of food.

b. Description of the Prior Art

Restaurants generate a large volume of soiled tableware. This soiled tableware is typically transported to a central processing/washing station in the kitchen. Tableware sorting and washing stations must process this large volume of tableware generated by ongoing food service operations.

Integrated systems have been proposed for a kitchenware washing station. For example, U.S. Pat. No. 6,092,541 to Crane et al., proposes a compact kitchenware washing station. The station has three different sinks, which can covert to counter space for processing tableware. In addition, the device incorporates a washing apparatus, a spraying apparatus, and other elements intended to facilitate the washing of tableware in a compact space. While this sort of compact washing station may be appropriate for a very small restaurant, large restaurants cannot use this type of technology.

Instead, large restaurants utilize separate sorting, rinsing, and washing areas. The tableware is first placed in a central processing station where excess food is discarded into waste bins, and the tableware is sorted into various classes. For example, flatware is separated from ramekins, plates, and glassware. Each class of tableware is typically placed into a receptacle having therein some sort of rinse solution. Once a receptacle holding a particular class of tableware becomes full, it is then moved to a different station where the processing continues, eventually resulting in the placement of a receptacle full of a particular class of tableware in a washing machine for cleaning.

The current technology for the first sorting stage is very simple. A flat work surface is provided. Disposed on the flat work surface are one or more receptacles having therein wash solutions. Adjacent to the surface is a waste bin.

There is typically one or more persons assigned to stand in front of the sorting station. This person takes soiled tableware which is brought to them by the serving staff and/or the bus staff and dumps waste food into the waste bin. The person then places, for example, flatware in one receptacle, plates in another receptacle, glassware in a different receptacle, with ramekins going in a final receptacle. Each of these receptacles takes up space on the surface of the processing station. The conditions on the surface of the processing station can become quite crowded, with little room left over for the bus staff to set new containers of soiled tableware as they are brought in. This lack of surface space on the processing station can present a bottleneck in the operation. In addition, it is common practice for bus staff and others bringing tableware into the processing station to throw various pieces of tableware into the receptacles, with wash solution therein. The result is that wash solution gets splashed all around, and quite a bit gets splashed on the person(s) manning the sorting station. This splashing of washing solution on the person(s) manning the sorting station can result in fights and/or disagreements among the kitchen staff.

Therefore, there can be seen that there are two primary problems with the type of sorting stations typically used in restaurants. First, space is at a premium on the surface of these sorting stations, and having receptacles full of sorted tableware sitting on the top surface of these sorting stations takes up space which is badly needed for other functions. Second, the constant throwing of tableware into the receptacles full of wash solution causes lots of splashing, which results in disputes among kitchen staff in large restaurant dishwashing areas.

The term “tableware” will be used throughout this patent to mean plates, glassware, flatware, such as knives, forks, spoons, and the like, and all of the utensils normally associated with the preparation, serving, and eating of food. It includes pots, pans, mixing bowls, utensils, and other items used in the cooking and preparation of food.

In addition, there will be two “stations” referred to in a typical restaurant for processing soiled tableware. The “first station” or “sorting area” is where uneaten food is placed in a waste container, and the various types of tableware are sorted into classifications. The “second station” is the “washing” station where the soiled tableware is cleaned and sanitized. The second station may be sub-divided into a “rinse” station and a “wash” station. The present invention relates to an improvement intended primarily for use is the sorting station. In particular, the present invention is intended to minimize the problem with splashing noted above, as well as to free up space on the surface of a typical sorting station, which was previously taken up by receptacles for the various types of tableware.

The prior art has largely focused on improving the effectiveness and efficiency of the washing operation. That is, prior art has focused on improving the effectiveness of removal of soiled food particles and the like from tableware. There has been little attention paid in the prior art to methods intended to improve the hectic process of washing tableware in a restaurant. Anyone who has ventured into a restaurant at a busy time can attest to the fact that it is quite a hectic operation. There are tens, if not hundreds, of people running back and forth to deliver food and drinks, and to return soiled tableware to the kitchen area for processing.

Therefore, there is a need for improvements to facilitate the process of cleaning soiled tableware. Improvements that can improve the flow of people and tableware through the processing system can result in costs savings, as well as less problems with the personnel. Tension among kitchen staff is a common source of turnover, which is a tremendous problem for restaurants. Personnel in the tableware washing areas are typically paid minimum wage or close to minimum wage, and it is difficult to find reliable people to fill these positions. Therefore, the invention that can help them out in the daily jobs to minimize the hassles they face it is likely to reduce turnover, which can result in significant benefits for a restaurant.

### SUMMARY OF THE INVENTION

There is provided a commercial tableware washing chute for use with a tableware sorting station. The chute comprises an attachment means for affixing it to an upper surface of the sorting station; a hollow body defining an upper entrance which is disposed adjacent to the upper surface of the sorting station; and a lower exit disposed adjacent to an edge of a lower surface of the station, whereby soiled tableware placed in the entrance is conveyed downwardly through the hollow body and out of the exit into a receptacle disposed on the lower surface. Preferably, the receptacle contains some sort of rinse solution.

The attachment means can be any number of well known technologies for attaching an appliance to an edge of a surface. In one embodiment, the attachment means is a rounded lip adapted to releasably engage a corresponding rounded edge of an upper surface of the sorting station. These sorting stations typically have a rounded edges to keep soiled food or fluids thereon from falling off of the sorting station surface and onto the floor. Alternatively, where there is no rounded lip, an attachment means can have a flat surface adapted to releasably engage the underside of the sorting station's upper surface. The attachment means could also use a clamp with either a spring biasing means or a screw-type biasing means to provide gripping power.

Within the hollow body of the chute, there can be at least one internal divider partitioning the chute into at least two separate conveyance means for conveying different types of tableware to different receptacles. Where one or more dividers are provided, it may be desirable to have a deflector disposed at the exit for deflecting tableware passing therethrough in to the proper receptacle. The same effect can be achieved by providing two or more separate chutes adjacent to one another for conveying different classes of tableware. When separate chutes are provided, it may be desirable to provide a means for attaching them together as a single unit.

The chute is used in conjunction with a commercial tableware sorting station comprising an upper surface having an edge, a lower surface also having an edge, at least one receptacle disposed on a lower surface for receiving soiled tableware; and at least one chute having a hollow body, as noted above, so that soiled tableware placed in the entrance is conveyed downwardly through the chute into the appropriate receptacle for subsequent transfer to a tableware washing station. The sorting station is designed to be used in a method of processing soiled tableware comprising: (a) the washing station with at least one chute associated therewith; (b) sorting the tableware and placing it into the proper chute; and (c) replacing full receptacles with empty receptacles as needed.

### BRIEF DESCRIPTION OF THE DRAWINGS

FIG. 1 is a perspective view of a chute adapted to engage a rounded edge of a sorting station.

FIG. 2 is a perspective view of a chute adapted to engage a flat edge of a sorting station, with attachment means for the underside of said sorting station.

FIG. 3 is a detailed cross section of the attachment means used in FIG. 2.

FIG. 4 is a perspective view of a chute attached to a sorting station.

FIG. 5 is a perspective view of a chute having an internal divider therein with a deflector at its exit.

### DESCRIPTION OF PREFERRED EMBODIMENTS

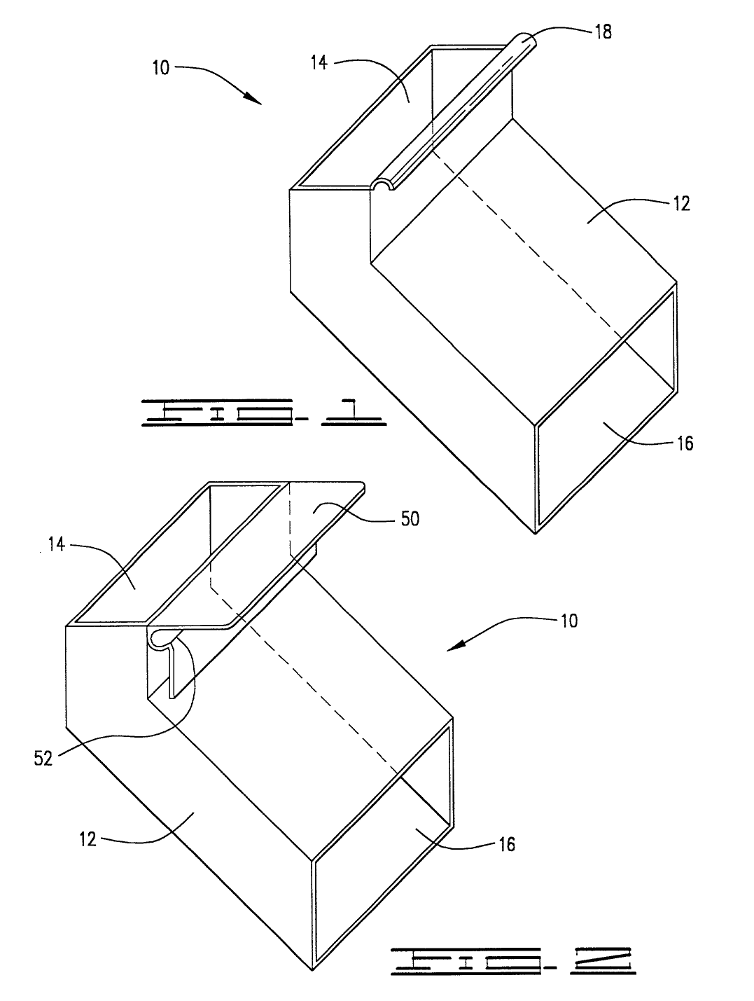

FIG. 1 is a perspective view of a chute for use with a commercial tableware sorting station. The chute 10 comprises sidewalls 12 defining both an entrance 14 and an exit 16. Adjacent to the entrance 14 is a rounded lip 18.

Most of the equipment used in a typical tableware processing station is stainless steel. Therefore, it is anticipated that the chute 10 will be constructed of stainless steel. However, it could also be constructed of some sort of injected molded plastic, or any other appropriate material. Considering the environment in which the chute will be used, the material of construction must be at least water resistant so that it does not rust or otherwise corrode when exposed to water and potentially harsh washing chemicals. In addition, it must be capable of being sanitized relatively easily. Therefore, as noted, the preferred materials are either some sort of injected molded plastic or some sort of stainless steel.

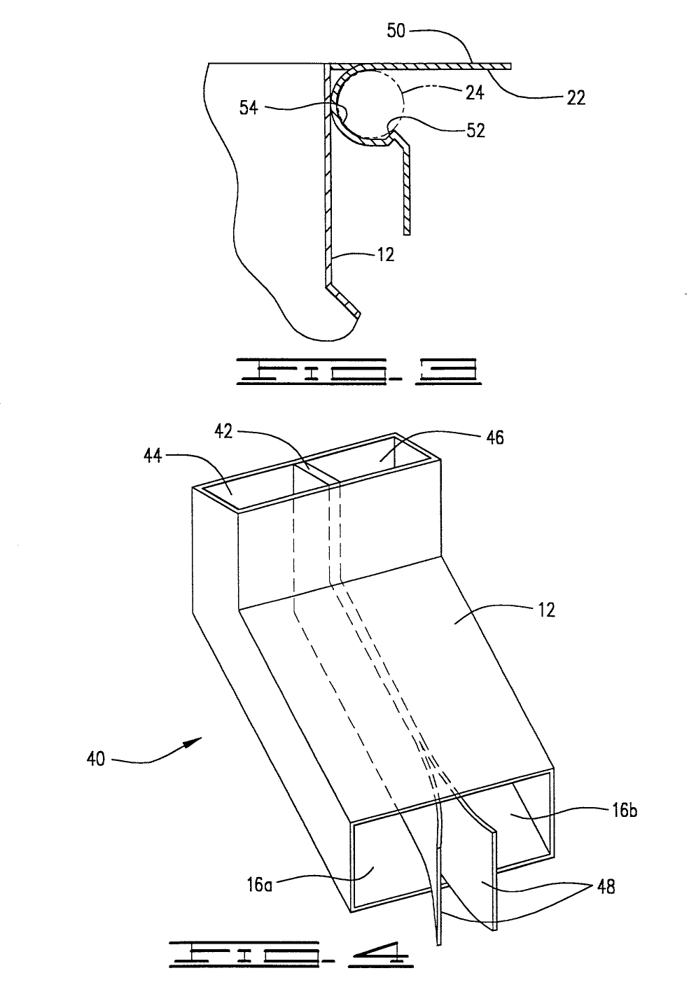

By way of example, and not limitation, the entrance 14 may have a depth of approximately four inches and a width of approximately ten inches. However, the size of the chute will be dictated by the type of tableware being processed. The distance between the entrance 14 and the exit 16 will be dictated by the distance between an upper surface of the processing station and a lower surface thereof. That is, the chute 10 must be an appropriate length between the entrance 14 and the exit 16 so that tableware placed in the entrance is conveyed downwardly to a receptacle placed on a lower surface of the processing station. In many commercially available processing stations, the distance is approximately fifteen to twenty inches. In addition to conveying the tableware downwardly, the tableware will also need to be generally conveyed inwardly away from the edge of the lower surface, thus the tableware is conveyed in to the waiting receptacle not just to its edge. FIGS. 1 and 2 show the biasing of the chute 10 backwardly to convey the tableware inwardly towards the receptacle.

FIGS. 2 and 3 show a chute for use with a processing station which does not have a rounded edge. Unlike the configuration shown in FIG. 1, the configuration shown in FIG. 2 has a flat lip 50 instead of a rounded lip 18. In addition, in cooperation with the flat lip 50, an engagement ridge 52 is adapted to releasably engage an underside surface 54 of the upper surface 22.

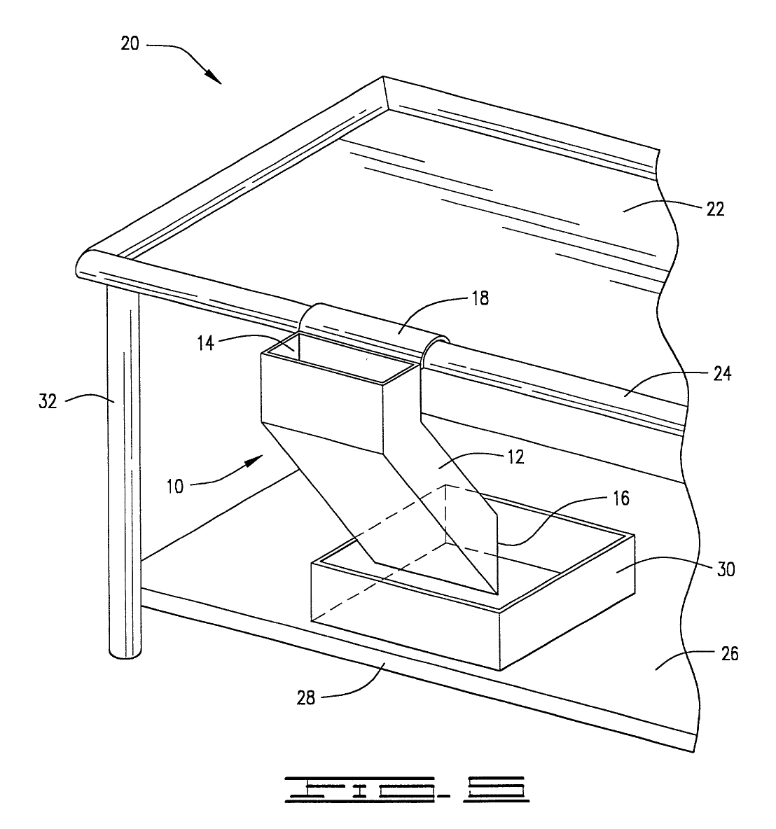

FIG. 4 illustrates the chute 10 attached to a washing station 20, having an upper surface 22 with an upper edge 24, which upper edge 24 is rounded, a lower surface 26 with a lower edge 28. Resting on the lower surface 26 is a receptacle 30. Both upper and lower surfaces, 22 and 26 respectively, are supported by support legs 32. As shown, the configuration is a standard table with four support legs 32. The chute 10 has a rounded lip 18 which engages the corresponding upper edge 24. It descends downwardly adjacent to the receptacle 30 so that tableware placed in the entrance 14 is conveyed through the chute 10 into the receptacle 30.

FIG. 5 shows a divided chute 40. The divided chute 40 has sidewalls 12 like the chute shown in FIGS. 1 and 2. However, in addition, the divided chute 40 has a divider 42. The single divider shown creates a first conveyance 44 and a second conveyance 46. As shown, the divided chute 40 is provided with a deflector 48 adjacent to the two exits, 16a and 16b, from the first conveyance 44 and the second conveyance 46. The purpose of the deflector 48 is to ensure that tableware dropped through the first conveyance 44 and the second conveyance 46 are transmitted to the appropriate receptacle waiting there below.

### OPERATION

In operation, the chute is attached to a tableware sorting station. Attaching the chute is relatively self-explanatory, but a brief description will be given. Where the sorting station has a rounded lip, the rounded lip on a chute is simply laid over the rounded lip of the sorting station. Where the sorting station is flat, the engagement ridge 52 fits into contact with the underside surface 54 of the upper surface 22 and in cooperation the engagement ridge and the flat lip hold the chute in place.

Once attached to the sorting station, a person working at the sorting station would take the soiled tableware and discard the extra food, napkins, and the like into the bin, and places the tableware into the appropriate chute for the class of tableware at hand. For example, if the person working at the sorting station has several plates with forks and ramekins thereon, the person places the silverware in one chute, the ramekins in another chute, and potentially the plates in a third chute. The chutes would convey the tableware into the appropriate receptacle on a lower shelf.

Once the receptacle containing a particular class of tableware was full, it would be taken to the washing station, and a new receptacle would be placed on the lower shelf.

Thus having described the field of the invention, the prior art, the attached drawings, the summary of the invention, and the detailed description of the preferred embodiments, I claim:

1. A tableware chute for use with a tableware sorting station, the chute comprising:
a. an attachment means for attaching the chute to an upper surface of the sorting station;
b. a hollow body defining an upper entrance and a lower exit, the entrance disposed adjacent to an edge of the upper surface, and the exit disposed adjacent to an edge of a lower surface of the station, whereby soiled tableware placed in the entrance is conveyed downwardly through the hollow body and out of the exit into a receptacle disposed on the lower surface.

2. The chute of claim 1 where the attachment means is a rounded lip adapted to releasably engage a corresponding rounded edge of the upper surface.

3. The chute of claim 1 where the attachment means is a flat lip adapted to rest on a flat portion of the upper surface and an engagement ridge adapted to releasably engage an underside surface of the upper surface.

4. The chute of claim 1, the hollow body having at least one internal divider partitioning the chute into at least two separate conveyance means for conveying different types of tableware to different receptacles.

5. A tableware sorting station comprising:
a. an upper surface having an edge;
b. a lower surface having an edge;
c. at least one receptacle disposed on the lower surface for receiving soiled tableware;
d. at least one chute having a hollow body defining an upper entrance and a lower exit, the entrance disposed adjacent to the upper edge, and the exit disposed adjacent to the lower edge, whereby soiled tableware placed in the entrance is conveyed downwardly through a chute into a receptacle for subsequent transfer to a tableware washing station.

6. A method of processing soiled tableware comprising:
a. providing the washing station of claim 5;
b. providing a chute for each class of tableware;
c. sorting tableware into classes and placing it into the proper chute; and
d. replacing full receptacles with empty receptacles as needed.
